(19) United States
(12) Patent Application Publication
(10) Pub. No.: US 2008/0236297 A1
(43) Pub. Date: Oct. 2, 2008

(54) Acoustically compatible insert for an ultrasonic probe

(76) Inventors: Geoff Van Fleet, Ithaca, NY (US); Jason Cortell, Freeville, NY (US); Kevin Lutkins, Union Springs, NY (US)

Correspondence Address: Randall Reed, 34 Dutch Mill Road, Ithaca, NY, 14850, US

(21) Appl. No.: 12/009,845

(22) Filed: Jan. 22, 2008

Related U.S. Application Data
(60) Provisional application No. 60/881,926, filed on Jan. 23, 2007.

(51) Int. Cl. G01F 1/66

(52) U.S. Cl. 73/861.28

(57) ABSTRACT

A probe system for measuring fluid flow in a conduit, such as a blood vessel with ultrasound transit time or similar measurement methods. The probe system having a probe body with a space to receive in a secure but detachable fashion a pliable soft insert. The insert has a central lumen or aperture which is sized to securely but detachably fit around a vessel or conduit without squeezing or in any way altering the conduit during application or use. The insert is acoustically matched with the vessel or conduit and fluid flowing therein to thereby minimize distortion or attenuation of ultra sound waves generated to assess flow. In a further aspect a set of inserts with varying sized lumens or apertures are provided to match with vessels or conduits of varying size. The system among other things increases accuracy of flow measurements while minimizing trauma to the vessel or conduit.

### CROSS-REFERENCE TO RELATED APPLICATIONS

The present application claims priority under 35 USC § 119 (e) from U.S. provisional application Ser. No. 60/881926 filed Jan. 23 2007 titled Acoustically Compatible Elastometic Cuff Insert for Ultrasound Probes or Disposable Insert for a Perivascular Probe

### STATEMENT REGARDING FEDERALLY SPONSORED RESEARCH OR DEVELOPMENT

Not applicable.

### REFERENCE TO A “SEQUENCE LISTING”

Not applicable.

### FIELD OF THE INVENTION

The present invention relates to ultrasonic probes used to measure fluid flow, more particularly it relates to an ultrasonic probe with a single or multiple use insert that secures the probe to a conduit and provides an acoustical path with minimal distortion of ultrasound transmissions generated to measure flow.

### BACKGROUND OF THE INVENTION

Use of ultrasound to measure and access flow in a conduit or a blood vessel has been well known in the art for years. U.S. Pat. No. 4,227,407, which is incorporated herein by reference, describes a system that measures volume flow with transit time ultrasound.

In the typical transit-time ultrasound flow sensor system flow is measured by the passage time of an ultrasound signal between two transducers where the signal passes through the flowing stream of fluid in a conduit or vessel on its passage from one transducer to the other. These measurements are used to determine flow volume by one of the two following methods: differential or common-mode transit time as follows: a) Differential Transit Time: the flow of liquid shortens the ultrasound transit time in downstream direction, and lengthens the transit time in upstream direction. The difference between alternate measurements of upstream and downstream transit times can thus be used as a measure of flow rate through the conduit. b) Common-mode transit time: the average value of a downstream and upstream transit time is a measure of the acoustical velocity of all the media between transmitting and receiving transducers. By introducing a change in this liquid's acoustical velocity (e.g. via the introduction of a bolus of a different liquid, or a momentary change in temperature) it can thus be used as an indicator dilution sensor (see, for example, the methods disclosed in U.S. Pat. Nos. 5,453,576 and 5,595,182, herein incorporated by reference).

All such sensors can measure flow parameters in conduits by employing ultrasound transit-time principles of operation with full flow illumination, wherein the flow cross-section is practically fully and homogeneously illuminated by an ultrasonic beam (Cornelis Drost, U.S. Pat. No. 4,227,407; Shkarlet Yuri, U.S. Pat. No. 6,098,466 incorporated herein by reference).

Other methods exist which are also used to measure flow including those based on electromagnetic sensing, Doppler ultrasonic methodologies and some that use Laser Doppler systems.

A typical ultrasonic transit time device (UTT) consists of 2 to 4 transducers which alternate between send and receive modes. When an electrical pulse stimulates a transducer in send mode, an acoustic wave is broadcast towards a transducer in receive mode which is properly aligned to receive such a signal. The ultrasonic paths, which are defined by the transducers' height, width and orientation, will encompass the entire conduit in which the fluid is flowing so that an accurate full volume flow measurement is possible.

As most fluid conduits are round and most ultrasound transducers, in particular those used for transit time ultrasound readings, have a flat wave generation surface, a varying volume of space typically exists between the transducer and the conduit. Air is a very poor medium which to transmit ultrasound wave through so this space between the transducer and conduit needs to be filled with a saline solution, an acoustic couplant, protective wrapping or if a chronic implant in an animal or human patient by tissue in-growth between the transducer and conduit. However, the saline solution, acoustic couplant or wrapping often can get displaced over time; this is especially true when placed near a beating heart or some other moving part of the body. Also, the protective wrapping is often not acoustically transparent and tissue in-growth takes time to grow in, leaving a time period where accurate measurements are not available.

While the shape of a biological conduit can be estimated accurately, the outer diameter can vary significantly from individual to individual and thus cannot be estimated until the individual is opened up and the vessel examined. Thus, up to the present the only solution in the prior art was and is to determine an outer diameter of a vessel by visual observation once the patient or animal is opened up during a surgical procedure and the vein or artery is exposed. Thus, it is not possible to be certain that the appropriately-sized flow probes will be on hand during a procedure. Given the potentially wide variation in exterior vein or artery diameter it is not currently economically feasible to have a large number of flow probes of different sizes sterilized and on hand during each surgery to ensure a proper fit. Additionally, one cannot over-emphasize the need for eliminating any air space between the probe's transducer surface and the exterior of the vein or artery. In order to obtain any useable results a proper fit that eliminates any potential air pockets which can cause unwanted reflection of the ultrasonic wave must be established between transducers and the artery or vein selected for flow measurement. A proper fit will also support the vessel and minimize the amount of movement of the vessel when readings are taken. One problem that occurs that often prevents this are body fluids that can seep into the space between the probe and vessel, these can cause false readings of flow. Additionally vessels are susceptible to rupture when they are subjected to rubbing along a high friction surface, even when rounded. The current practice used to protect a vessel during flow probe installation is to wrap the vessel with a padding or mesh. There are probes that have adjustable pockets to hold the vessel; however, these tend to be cumbersome and difficult to use.

In certain instances, the application of the flow probe is limited by the health of the vessel. Any squeezing of the vessel can release plaque, which will migrate along the vessel and potentially cause clots. For applications where this is an issue, a probe must designed to be easily installed without disturbing the vessel. More importantly it must be capable of being removed without altering or damaging the vessel.

For use in quick spot measurements of flow, an ideal flow probe will be properly sized to the size of the vessel, quickly placed over the vessel, measurements taken, and then easily removed without disrupting the vessel. The current art lacks in the ability to perform this process without either squeezing a vessel or having large gaps that exist between transducers of the probe and the vessel or artery from which flow measurements are to be obtained.

### SUMMARY

Thus, it is an objective of the present invention to solve the problems mentioned above and provide a system with a probe that is easy to install and provides an accurate and correct fit around a conduit or vessel without gaps, thus providing an attenuation-free as possible acoustic connection between the probe and vessel. It is a further objective to provide an apparatus to improve the safety and effectiveness of ultrasonic transit-time flow measurement.

The present invention and its various aspects achieves these and other objectives by providing a system that employs a disposable cuff insert which correctly positions a perivascular probe along an axis perpendicular to a fluid conduit, such as an artery or vein, without influencing the vessel in any way. An insert that securely fits into the interior space of the probe has an opening through its center that allows the insert to securely surround a vein or artery of an outside diameter equivalent to the opening in the center of the insert. Inserts with varying openings through their center allow for selection of an insert with an opening that is properly sized to securely fit around veins or arteries of varying size. The ultrasonic path between transducers is then comprised only of the cuff insert which is ultrasonically matched to the conduit, reducing ultrasonic reflections and the need for an acoustic couplant.

In another variation of the present invention it provides an insert for a perivascular probe with: a) a probe insert with a body made of a pliable flexible material having a lumen surface formed on an interior portion of the insert, the lumen surface ending at two opposing openings and thereby defining an aperture through the insert, which aperture is sized such that the lumen surface can be securely, snugly and detachably fitted to a portion of an exterior surface of a fluid conduit with a specific exterior dimension, the insert also including a split region to facilitate fitting of the insert to the fluid conduit; b) the probe insert having an exterior surface configured to securely but detachably fit within an interior space of a probe body, the probe body having appropriately placed within it at least two ultrasonic transducers configured to exchange transmissions there between, which transmissions provide full flow illumination of the interior of a conduit positioned against the lumen surface of the insert, when the insert is positioned within the probe; and c) wherein the pliable flexible material of the insert is ultrasonically matched to material making up a conduit held by the insert and fluid flowing in the conduit to thereby eliminate distortion of ultrasonic transmissions passing through the conduit.

In yet another variation it provides a modular perivascular probe system with: a) a probe body forming an interior pocket to hold an insert in a secure but detachable and snug airtight fit; b) the probe body having at least two transducers positioned within itself to exchange ultrasonic transmissions there between; c) an insert made of a pliable and flexible material having an exterior surface configured to fit in a snug airtight fashion within the pocket formed by the probe body; d) the insert having an aperture there through formed by a lumen surface in an interior of the insert, the lumen surface ending at two opposing openings; the lumen surface is sized such that the lumen surface can be securely, snugly and detachably fitted around a portion of an exterior surface of a fluid conduit of a specific size, in an interior of the insert to thereby create an aperture there through; e) the lumen surface being configured to hold a vessel in a position that ultra sonic transmissions between the two transducers fully illuminate flow of liquid in the conduit; f) wherein the pliable flexible material of the insert is ultrasonically matched to material making up the conduit held by the insert and fluid flowing in the conduit to thereby eliminate distortion of ultrasonic transmissions passing through the conduit; and g) wherein the at least two transducers are connected by a communication link to a cpu, which cpu is programmed to control the operation of the at least two transducers and obtain signal information from signals transmitted between the at least two transducers to thereby obtain information regarding fluid flowing in the fluid conduit.

### BRIEF DESCRIPTION OF THE DRAWINGS

The invention will be better understood by an examination of the following description, together with the accompanying drawings, in which:

FIG. 1 is a perspective view of a preferred embodiment of the insert cuff and probe body of the present invention positioned adjacent to each other;

FIG. 2 is a face view of a preferred embodiment of an insert cuff of the present invention secured in the pocket of the probe body;

FIG. 3 is a face view of a preferred embodiment of the probe body of the present invention;

FIG. 4 is a view of the probe body of FIG. 3 along lines IV-IV;

FIG. 5 is a perspective view of a preferred embodiment of the insert of the present invention;

FIG. 6 is a perspective view of a preferred embodiment of the insert of the present invention being secured around a vessel;

FIG. 7 is a perspective view of a vessel with an insert secured around it and the insert positioned in the pocket formed by a probe body:

FIG. 8 is a perspective view of a vessel positioned in the pocket of a probe body without the insert;

FIG. 9 is a view of the bottoms of the probe body and insert adjacent to each other;

FIG. 10 is a view of the vessel with insert around it and insert in the probe body of FIG. 7 from the bottom from the perspective indicated by line X-X;

FIG. 11 is a front view of the vessel secured in the insert with the insert positioned in a probe body;

FIG. 11A is a schematic diagram of the electrical circuitry of the present invention;

FIG. 12 schematic diagram of the configuration of the vessel secured in the insert with the insert in the probe body of a cross-section perspective viewed along line XII-XII of FIG. 10;

FIG. 13 is a graph demonstrating what happens to a ultrasound wave that is incident at an oblique angle on a boundary between two ultrasound transmissive media that have different acoustic impedances and velocities of sound;

FIG. 14 is a graph demonstrating what happens to a ultrasound wave that is incident at a perpendicular angle on a boundary between two ultrasound transmissive media that have different acoustic impedances and velocities of sound;

FIG. 15 is a schematic view of some of the components of system of the present invention and a conduit;

FIG. 16 is another schematic view of some of the components of system of the present invention and a conduit;

FIG. 17 is view of a set of inserts and a probe body with which they would be used; and

FIG. 18 is view of the set of inserts depicted in FIG. 17 as they would appear in a probe body.

FIG. 19 is a front view of another variation of the probe and insert of the present invention;

FIG. 19A is a side view of the probe in FIG. 19 along line 1XXA-1XXA;

FIG. 20 is a front view of another variation of the probe and insert of the present invention;

FIG. 21 is a side view of another embodiment of the present invention;

FIG. 22 is a top partial schematic view of the probe and insert of FIG. 21 along line XX1-XX1;

FIG. 23 is a top view of an insert of the variation of the invention depicted in FIGS. 21 and 22; and FIG. 24 is a perspective view of the insert depicted in FIG. 23.

### DETAILED DESCRIPTION OF THE PREFERRED EMBODIMENT

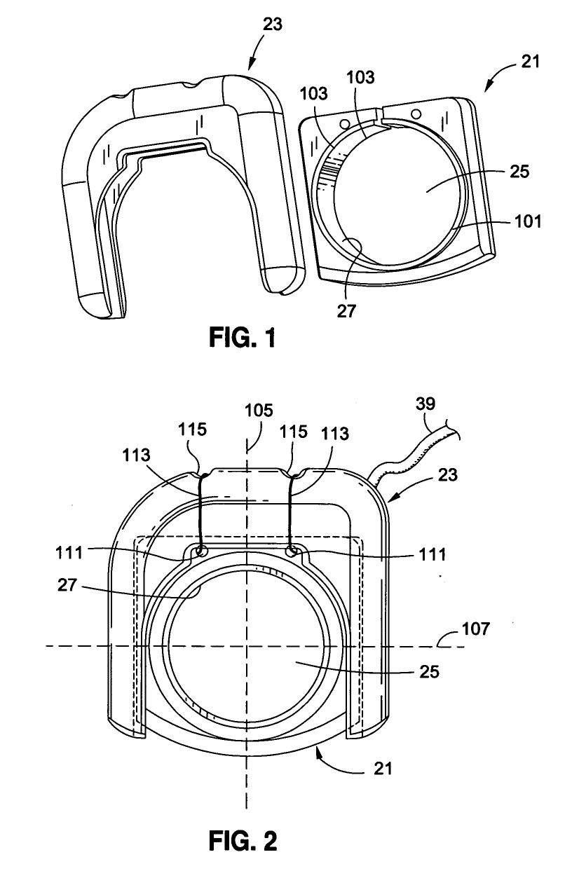

The present invention provides an apparatus and method for accurate, efficient and cost effective measurements of fluid flow such as blood in conduits and vessels of varying size. In its preferred embodiment the apparatus is used in conjunction with ultrasonic transit-time measurements in conduits and vessels such as arteries and veins. FIG. 1 provides a perspective view of an insert cuff 21 of the present invention adjacent to a probe body 23. FIG. 2 provides a face view with insert cuff 21 positioned in probe body 23. As will be discussed in detail below aperture 25 in insert cuff 21 would be secured around a vessel or conduit such that lumen surface 27 of insert 21, which forms aperture 25, would be detachably abutted against the outside wall of the vessel or conduit before insert 21 is inserted into probe body 23 as depicted in FIG. 2.

In its preferred embodiment insert cuff 21 is produced by an injection molding process and is made of a pliable and elastic rubber like material that is acoustically matched to the conduit or vessel it is positioned around the fluid flowing in that conduit. The preferred embodiment of the present invention measures blood flow in a conduit or vessel, thus the material insert 21 must be acoustically matched and biocompatible with blood and the blood vessel around which it will be positioned. Acoustically matched means that the material of insert 21 and the blood vessel and blood flowing in the vessel must have the same or a very close acoustic impedance and acoustic velocity. Such a properly chosen material for insert 21 must not distort sound waves or focus the acoustical field on the center of the flow lumen formed by aperture 25, but rather maintain “full flow illumination”. Prior art, described in U.S. Pat. No. 7,194,919, incorporated herein by reference outlines the requirements of an ideal material that provides full flow illumination.

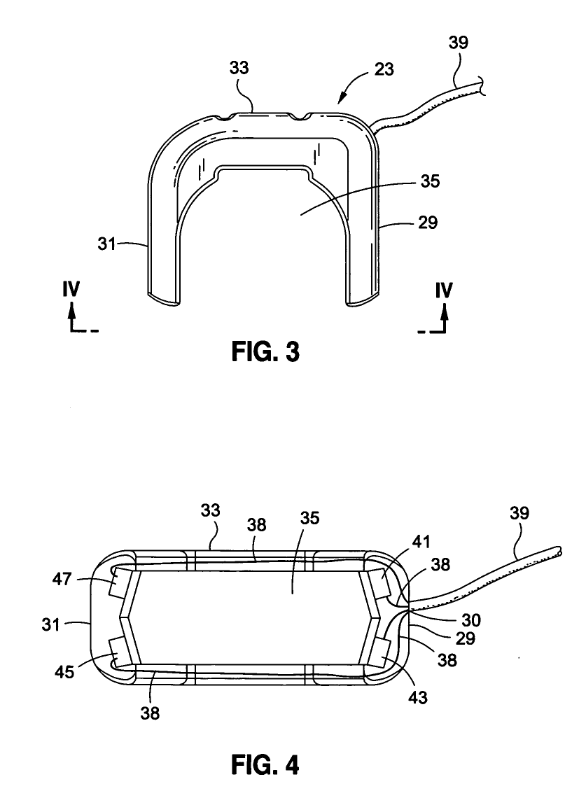

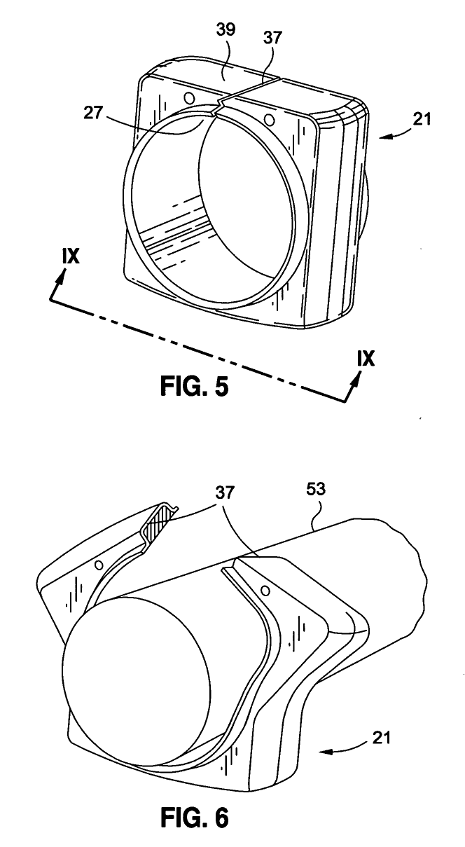

FIG. 3 provides a raised view of probe body 23 with its two legs 29 and 31 that are connected by superstructure 33. Space 35 is formed between legs 29 and 31 to receive insert cuff 21, FIGS. 1 and 2. In the preferred embodiment of the present invention probe body 23 is made of a rigid plastic like material such as a biocompatible epoxy. FIG. 4 provides view along line IV-IV of FIG. 3 wherein one looks into space 35 formed by legs 29 and 31 in probe body 23. In the preferred embodiment of the present invention transducers 41 and 45 are positioned within leg 29 and transducers 45 and 47 are positioned in leg 31. Transducers 41 and 45 are positioned to exchange transmission of ultrasound waves across space 35 and Transducers 43 and 47 are positioned to exchange transmission of ultrasound waves across space 35.

Referring to FIG. 5 insert 21 has a split 37 that runs from the exterior surface 39 of insert 21 to lumen surface 27. As depicted in FIG. 6 split 37 allows the opening up of insert 21 because it is a pliable rubber like material and thus positioned over conduit or vessel 53 without squeezing or disturbing vessel 53. Insert 21 is selected such that aperture 25 has approximately the same diameter as the outside diameter of the vessel or conduit around it will be secured.

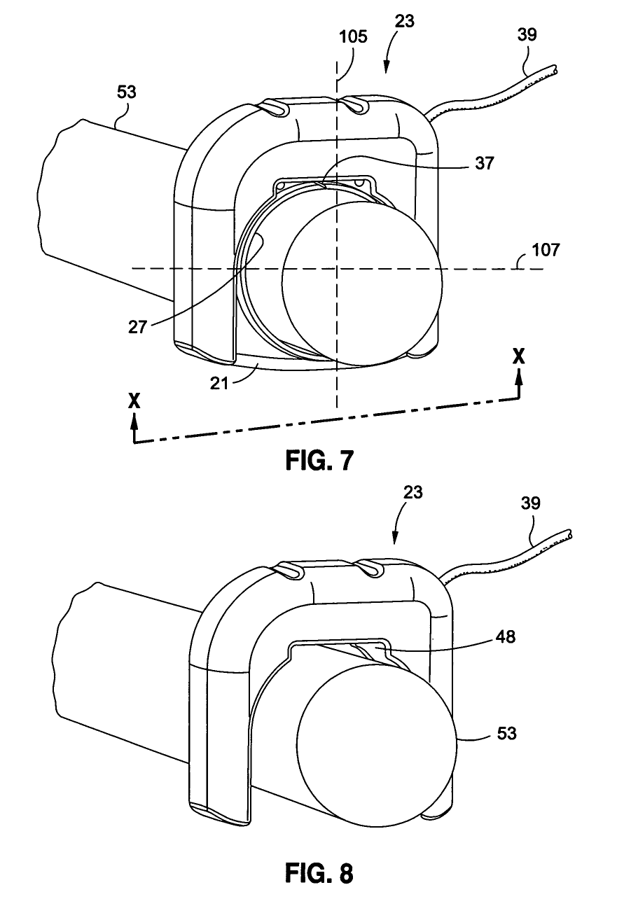

After insert 21 is secured in a detachable fashion around vessel 53 it is inserted into probe body 23 as depicted in FIG. 7. As depicted in FIG. 7 insert 21 is securely positioned around vessel 41 with lumen surface 27 in full contact with vessel 41. In turn insert 21 is secured inside probe body 23. FIG. 8 is provided to emphasize the function of insert 21 in that FIG. 8 shows vessel 53 in probe body 23 without insert 21. As can be seen space 48 is that area that would normally be filled up with the insert cuff. The arrangement depicted in FIG. 8 is non-functional since it leaves a gap 48 with air between the transducers of probe body 23 and vessel 53.

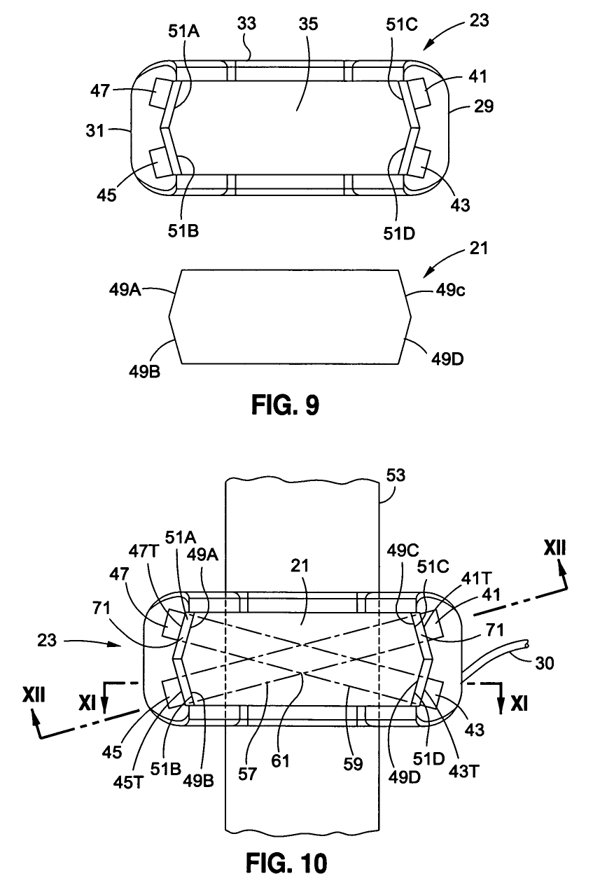

FIG. 9 provides a side by side view of the bottom of the probe body 23 along line IV-IV of FIG. 3 and a view of the bottom of the insert 21 along line IX-IX of FIG. 5. In comparing in FIG. 9 the view of insert 21 with the view of space or pocket 35 formed in probe body 23 it can be seen that the insert is sized to snugly fit into space or pocket 35. In order to properly practice the present invention a sealed generally air tight fit with very few or no air bubbles between the exterior surfaces 49A, 49B, 49C and 49D of insert 21 and interior surfaces 51A, 51B, 51C and 51D of probe body 23 must be achieved when insert 21 is placed in space or pocket 35 within probe body 23.

Accuracy of the flow measurements taken by the present invention is one of the paramount goals. As noted above the invention measures flow with transit time ultrasound measurements. To help achieve accuracy in its measurements the present invention relies on planar ultrasound transducers sized to fully illuminate a complete cross-sectional area of the vessel. This requires production by the transducer in transmit mode of a substantially coherent planar wave of ultrasound as wide as or wider than the vessel under study wherein sufficient coherence of the wave and wave front of the generated wave is maintained along the acoustic path between the transmitting transducer and the receiving transducer, such that all parts of the ultrasound wave front arrive substantially in phase at the receiving transducer. Some of the features of the present invention that help achieve this goal of full coherent flow illumination of the vessel or conduit are: a) providing a transducer wide enough to generate an ultrasound wave that covers an entire cross-sectional area of the vessel or conduit, b) positioning the transmission face of the transducers so that the acoustic wave is perpendicular to the boundary between the probe body and the insert and such that the advancing ultrasound wave front will present a flat planar face that is parallel to this boundary between the probe body with embedded transducer and the insert, c) assuring there is a snug airtight fit between the surface of the probe body where the transducer is located and the adjacent portion of the insert, and d) matching the acoustic impedance and acoustic velocity of the insert to the vessel or conduit and the fluid flowing in the vessel or conduit to minimize reflection, refraction and acoustic focusing of the ultrasound waves at the boundaries between insert 21 and vessel or conduit 53.

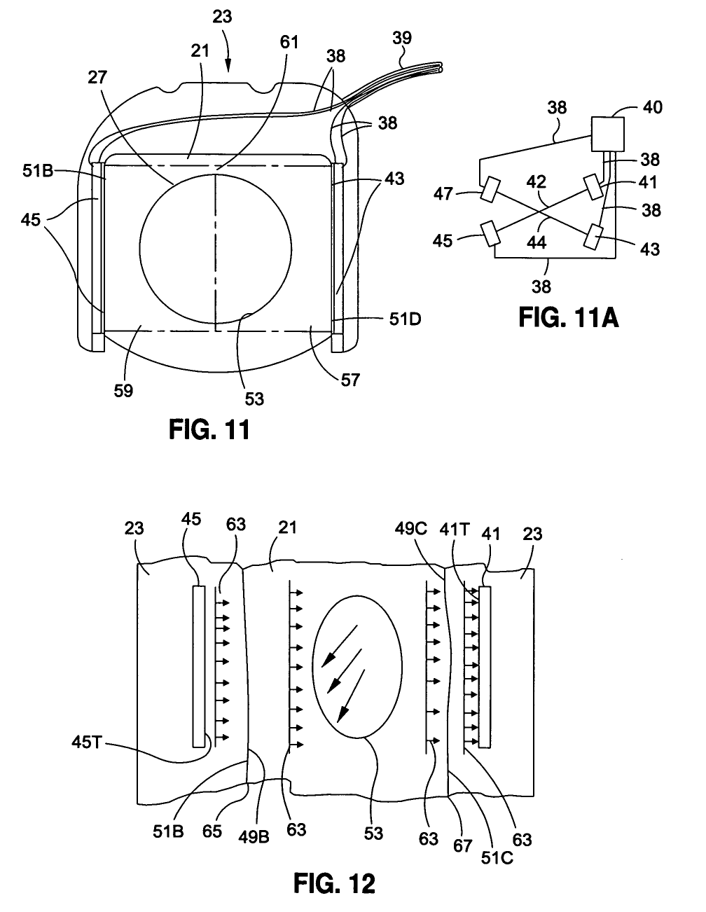

Referring to FIG. 10 the ultrasonic wave path 57 between transducer 41 and transducer 45 cuts across vessel 53 and the ultrasonic wave path 59 between transducer 43 and transducer 47 cuts across vessel 53. FIG. 11 is a raised cross-sectional view of vessel 53, probe body 23 and insert 21 along line XI-XI in FIG. 10. As depicted in FIG. 11 transducers 43 and 45 generate ultrasound waves that have paths respectively 57 and 59, which when taken in conjunction with the course of the paths in FIG. 10 it can be seen that they fully illuminate a complete cross-section of conduit or vessel 53 a required by the present invention.

Referring to FIG. 10 again it can be seen that the transmission faces 41T and 45T of each of transducers 41 and 45 face each other and are parallel to each other. Additionally, the boundary between probe body 23 and insert 21 formed by the abutting of surfaces 49C and 51C adjacent to transducer 41 is parallel to transmission surface 41T of transducer 41. Likewise the boundary between probe body 23 and insert 21 formed by the abutting of surface 49B and 51B adjacent to transducer 45 is parallel to transmission surface 45T of transducer 45. Likewise with respect to transducers 43 and 47, transmission surface 43T is parallel to interior surface 51D of the probe body, which in turn is parallel to exterior surface 49D of the insert which in turn is parallel to exterior surface 49A of the insert, which in turn is parallel to exterior surface 51A of the probe body, which finally is parallel to transmission surface 47T of transducer 47.

Transducers 41, 43, 45 and 47 are all individually electrically connected 38 to a flow meter 40 FIG. 11, FIG. 4 as well as FIG. 11A, FIG. 11A being a schematic diagram of the electrical and ultrasound connections of the invention. As depicted in FIG. 11 all of the individual electrical connections 38 are bundled together in electrical lead 39. Referring back to FIG. 11A signals from flowmeter activate the various transducers which generate ultrasound beams 42 and 44 which pass back and forth between the paired transducers 41 and 45 beam path beam path 42 and transducers 43 and 47 beam path 44. The ultrasound signal received by the transducer of the pair in receive mode converts the received ultrasound signal back into an electrical signal and sends it over its individual connection 38 to flowmeter 40. Flowmeter 40 than analyzes the signal and based on that signal or several received signals from each of the transducers determines flow rate. Flowmeter 40 is a dedicated computer with CPU, memory, graphic or electronic display, signal interface with the transducers and appropriate software that analyzes and stores the results. U.S. Pat. No. 4,227,407 previously incorporated by reference go into detail on the specific methods of calculating. Transonic Systems Inc. makes a T400 research flowmeter and HT 300 clinical flowmeter that would work with the probes as disclosed herein. In an alternative arrangement a general purpose computer running appropriate software with standard digital to analogue converter to connect to the transducers could be used instead of dedicated flowmeter.

FIG. 12 provides a cut away schematic, not to scale, view along line XII-XII of FIG. 10. In FIG. 12 a side view of transducers 45 appears adjacent to a side edge view of boundary 65 formed by surface 51B of probe 23 and surface 49B of insert. Also, a side view of transducers 41 appears adjacent to a side edge view of boundary 67 formed by surface 51C of probe 23 and surface 49C of insert. An oblique angle view of vessel 53 appears. As can be seen from this schematic diagram transducer transmission-reception surface 45T is parallel to boundary 65 which in turn is parallel to boundary 67 which in turn is parallel to transmission-reception surface 41T. Thus, if transducer 45 generates a planar ultrasound wave indicated by wave front 63, wave front 63 (depicted at multiple positions in FIG. 12 to show its movement) will pass through boundary 65 without refraction since the waves of wave front 63 are perpendicular to boundary 65, likewise it will pass through insert 21 and then through boundary 67 to eventually arrive at transmission-reception surface 41T of transducer 41 in a fairly coherent form with a fairly planar wave front do to this structural feature of parallel surfaces. (It is also due to the acoustic matching of the insert to the vessel fluid flowing in the vessel, which will be discussed in detail a few paragraphs below after the present discussion.) Arrows 50 in FIG. 12 are representative of fluid flowing in conduit or vessel 53, such as blood. Although, may not be specifically depicted every time in the drawings stated every time with references to conduits or vessels when discussing measurements of fluids flowing this can be presumed.

Planar wave front 63 and thus the ultrasound waves of which it consists, since these waves are arriving at boundary 65 with an orientation perpendicular to boundary 65 planar wave front 63 as it passes through boundary 65, will maintain its planar shape, coherence and homogeneity. This can be explained by Snell's law:

$$\frac{{sin}_{{θ}_{1}}}{{V}_{{L}_{1}}} = \frac{{sin}_{{θ}_{2}}}{{V}_{{L}_{2}}}$$

as it is applied to sound waves. When a sound wave arrives at a boundary between two different materials depending on the acoustic velocity and impedance of each material and the velocity of sound in each material three possible things can occur: a) the wave is in whole or part reflected back into the material it has just traveled through, b) the wave can in whole or part pass through and continue on in the same direction in the new material or c) it can in whole or part pass through and be refracted in the new material. The equation for acoustic impedance is Z=ρV, where Z is the impedance, ρ is the density of the media and V is the velocity of sound in the media. Generally, differences in acoustic impedance Z between the two different materials is primarily determinative of the amount reflected at the boundary between the two materials as opposed to passing through the boundary. The closer the impedance of the two materials is matched the more of the sound waves signal strength passes through rather to the new medium rather than being reflected back. The amount the sound wave is refracted as it passes through the boundary between the two materials is dependent primarily on the difference in velocity of sound in each of the two materials, the greater the difference in the velocity of sound the greater the refraction of the ultrasound waves. However, if the ultra sound wave passes through the boundary at an angle perpendicular to the boundary no refraction will occur as defined above in Snell's law.

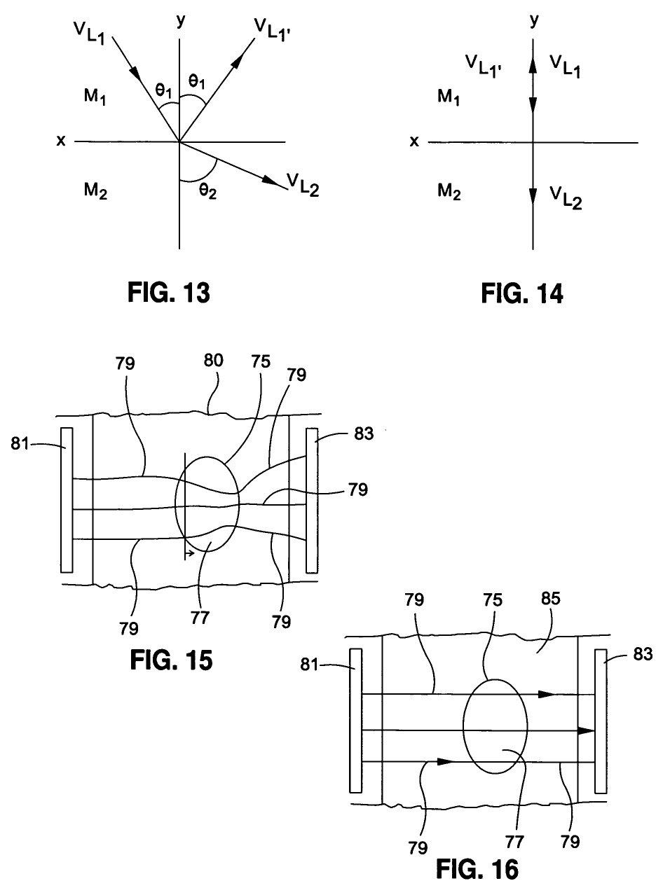

The effect of Snell's law described above is illustrated by FIGS. 13 and 14. FIG. 13 shows that when the direction of ultrasonic wave V_{L1} arrives at an oblique angle θ₁ (measured from the y-axis) to a boundary, the x-axis, between sound transmissive materials M₁ and M₂ each of which have different acoustic velocities and different acoustic impedances the portion of ultrasonic wave V_{L2} that passes into medium M₂ is going to diverge (be refracted) from the direction of ultrasonic wave V_{L1} at a different angle greater angle from the y-axis, θ₂. On the other hand as depicted in FIG. 14 if the ultrasonic wave V_{L1} arrives at a perpendicular angle to the boundary, the x-axis, between materials M₁ and M₂ the portion that passes into material M₂ continues in the same direction as V_{L1}. To improve performance and lessen reflection V_{L1}, the epoxy 71 FIG. 10 is selected to have an acoustic impedance Z₁ of the epoxy that is equivalent to

$${Z}_{1} = \frac{{( {Z}_{4} )}^{2}}{{Z}_{2}}$$

where Z₂ is the acoustic impedance of insert 21 material and Z₄ is the acoustic impedance of transducer 47. This is based on the following relationship:

Z₄=\sqrt{Z₁×Z₂}

which is a formula used to determine the best acoustic impedance matching between to materials to minimize attenuation and reflection of sound waves passing from one material where the sound waves are generated into a second material.

As depicted in FIGS. 9 and 10 and discussed at length above insert 21 is sized to fit snugly in pocket 35 of probe body 23 with an airtight fit between insert exterior surfaces 49A, 49B, 49C and 49D and matching exterior surfaces 51A, 51B, 51C and 51D. Probe body 23 is made of a hard substantially rigid material such as epoxy or other plastic like material while insert 21 is made of a pliable rubber like material. Thus, by properly sizing insert 21 with respect to pocket 35 of probe body 23 the necessary air tight fit can be achieved by proper manufacture of the insert and probe body.

The problem of acoustic focusing is another problem the present invention deals with. Acoustic focusing refers to the comparable effect of a lens has on light as it passes between two different medium with different indexes of refraction. For example when light passes from air into a lens its rays or wave fronts are diverted from their direction of travel to a new direction; thus, when the light passes out the other side of the lens it may be focused on a point or area different from what it originally was directed towards prior to entering the lens. Likewise with respect to ultrasound waves the index of refraction with respect to optics is equivalent to the acoustic impedance and difference in velocity of sound between two different materials. Just as a bigger difference between the index of refraction in two different mediums causes light to be reflected or refracted more when passing between two mediums so too with sound passing between two different materials with different acoustic impedance and acoustic velocity. Referring to FIG. 15 a schematic diagram of sound passing through an insert with a vessel and fluid flowing in it of significantly different acoustic velocities of sound. As can be seen vessel 75 and fluid 77 cause ultrasound waves 79 generated by transducer 81 and passing through insert 80 to bend and be focused at receiving transducer 83.

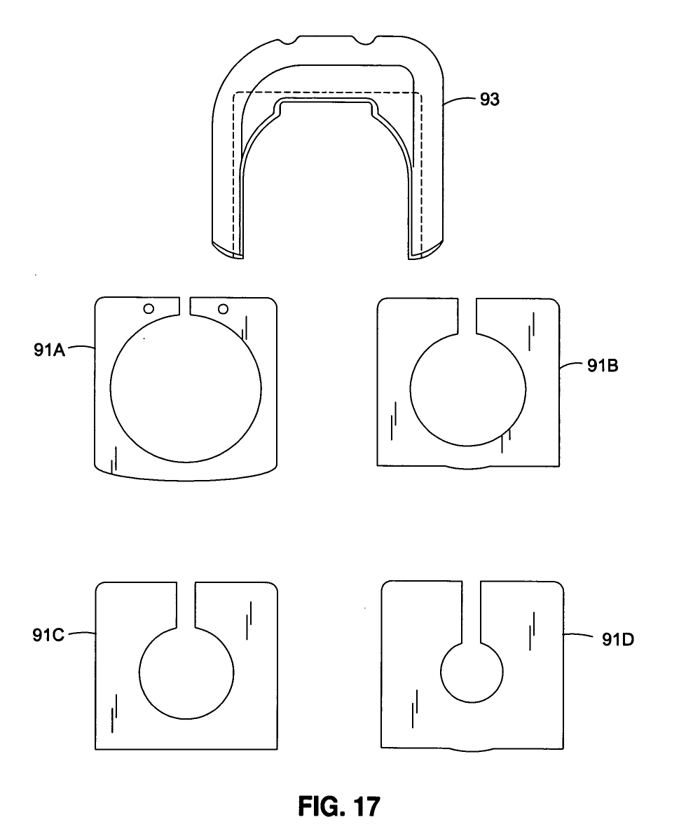

The present invention minimizes the “acoustic focusing” by ensuring that the acoustic velocity, speed of sound, in insert 21 is matched to that of the conduit and fluid flowing in the conduit. In the case of a preferred embodiment of the invention it involves matching the acoustic impedance and speed of sound in insert 21 such that it is the same or almost the same as that of blood and the veins and arteries of an animal and human. FIG. 16 is a schematic diagram illustrating the effect that matching the acoustic velocity in the insert 85 to the conduit 75 and fluid 77 flowing in the conduit has on ultrasound waves 79 generated by transducer 81 and received by transducer 83. As can be seen ultrasound waves 79 are not distorted in any significant way by passing through vessel 75 and fluid 77.

The choice of material for use in the single use insert is extremely important. The material must match the acoustical properties of the fluid which is to be measured; in most cases blood. The acoustical velocity of the material will have a dramatic effect on focusing of acoustical beams and overall probe reading. According to Snell's law, the larger the mismatch between velocities, the greater the refraction of waves between two materials. This was described in the patent. If the waves are greatly refracted, we lose “full flow illumination”. A secondary effect of acoustical velocity mismatch is that the flow measurement will be negatively impacted. Because of the curvilinear shape of the vessel, the number of waves which pass through each material is dependent upon position relative to the center of the vessel. For instance, the thickness of the insert is significantly thinner at its central axis as compared to the top of the lumen. If material acoustic velocities differ, the ultrasound transit time measurement will be off. The acoustical impedance match between two materials will determine the extent of reflection and transmission through the boundary. Because the acoustical impedance of a material can be determined by multiplying the density of the material with its acoustical velocity, two materials which have similar acoustical velocities will have similar impedances if their densities match. This invention stresses that an ideal material will have similar acoustical velocities and density to the fluid being measured.

In the preferred embodiment of the present invention the insert cuff can be made of Pebax 3533 manufactured by the Arkema or Tecoflex® manufactured by the Thermdics company. Naturally, any other material that is flexible and rubber like could be used provided the acoustic impedance and velocity of sound in that material could be matched to the conduit and fluid in the conduit under investigation such as an arteries and veins and blood flowing in them. A third property of an ideal material for insert 21 is one that has a stable acoustic velocity over the range of operating temperatures that the insert will experience. In many materials their acoustic velocity changes significantly with temperature changes. However, a material like Pebax changes very little in the range of 20 to 40 degrees C., the typical operating range that the insert of the present invention will be operating under. This ensures that the probe and insert can be calibrated and the results relied on over a significant temperature range.

The insert of the present invention contains no electrical components and given the type of material it is made of can be injection molded in high volumes and are extremely cheap to make in large numbers. Thus, the insert cuffs of the present invention are disposable and economical. Consequently, a surgeon will be able to have a number of insert cuffs with varying lumen diameters present and sterilized during the initial implantation and thus should be able to place an insert with the proper lumen size around the artery or vein to be monitored. Therefore, once the vessel is exposed, a proper size can be chosen so that the vessel is neither squeezed nor surrounded by open air or materials with varying acoustical properties. Adjustment to proper fit of the disposable insert cuff is as simple as choosing a cuff insert with a correctly sized lumen.

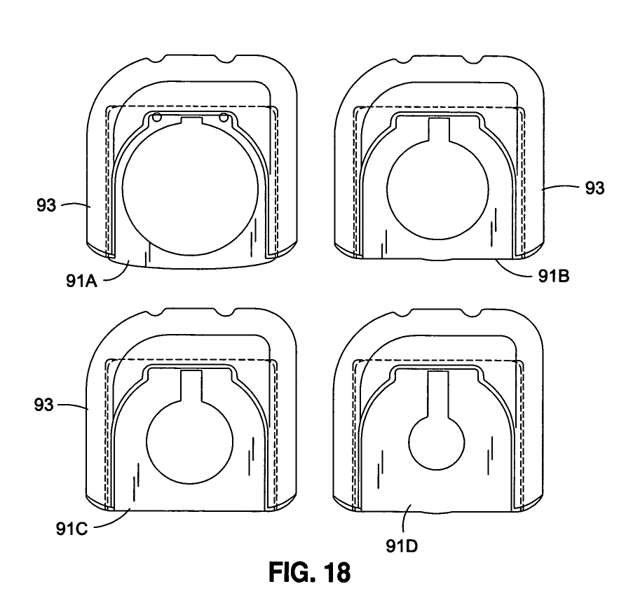

Sets of inserts with apertures formed by lumen surfaces of varying size designed to securely fit around the conduit or vessel could be made and used with one or two probe bodies. FIG. 17 provides an example of a probe body 93 that would be matched with the set of inserts 91A, 91B, 91C and 91D. FIG. 18 provides a view how each insert 91A, 91B, 91C and 91D might appear when inserted in probe body 93. FIGS. 17 and 18 or illustrative of the concept of a set of disposable insert. For use with animals of human sizes of the aperture 25 formed by lumen surface 27 might vary in 1 mm increments in diameter from 1 mm or 2 mm all the way up to inserts with apertures of 36 mm. A set might contain a set of inserts with apertures of diameters such as 8 mm, 10 mm, 12 mm, 14 mm, 16 mm, 20 mm, 24 mm, 28 mm, 32 mm and 36 mm. Also, it is possible to provide sets where the incremental change is smaller or bigger. Additionally, inserts could be specially made to very precise sizes down to a 10^{th} of a millimeter with a set say of 17 mm, 17.25, 17.5, 17.75, and 18 mm or even smaller gradations such as 17.54 mm lumen.

Thus, with the ability to make sets of inserts with finely graded aperture diameters a doctor or other health care professional will not squeeze or alter in any way a vein or artery when placing the flexible insert over the artery or vein. In the preferred embodiment, no wrapping or ultrasonic couplant is needed between insert and conduit. The transducers of the probe will maintain constant pressure against the cuff insert, ensuring minimal air pockets.

In another variation of the preferred embodiment a flange 101 FIG. 1 can be added to lumen surface 27 at openings 103 on either side of insert 21 which with lumen surface 27 form aperture 25. Flange 101 is an extension of insert material out from lumen surface 27 that makes the aperture wider than the width of insert 21. Flange 101 thus would create an extension of the aperture that would aid in assuring insert 21 and thus probe body 23 are properly aligned with vertical axis 105 and horizontal axis 107 FIG. 7 of the insert and probe body. This would be another way of helping assure the transducers are properly aligned with vessel 53. In a preferred embodiment the extensions can be thin no more than 1 mm thick and extend out from the insert from 2 mm to 3 mm.

In the preferred embodiment insert 21 can be secured in detachable but secure fashion inside probe body 23. One such a way is to simply make insert 21 with a slightly oversized fit between probe and insert provides a means to prevent the insert from moving relative to the probe. In another way suture holes 111 FIG. 2 are placed strategically in insert 21 which allow for sutures 113 to be secured through suture holes 111 and over notches 115, to allow for extra support if needed. In another embodiment of the invention, the insert is held close against the transducer surface by clips. These clips maintain a force pressing the insert both towards the transducers and towards the bottom of the probe. They provide a mechanism to quickly lock down the insert to prevent it from moving during measurements as well as provide a method to rapidly remove the insert and probe when needed. In another embodiment, the probe itself contains a ledge that the insert is held under to maintain position.

In a preferred embodiment of the invention, the insert cuff is disposable. They can be initially sterilized by a variety of methods including EtO, Sterrad and gamma radiation.

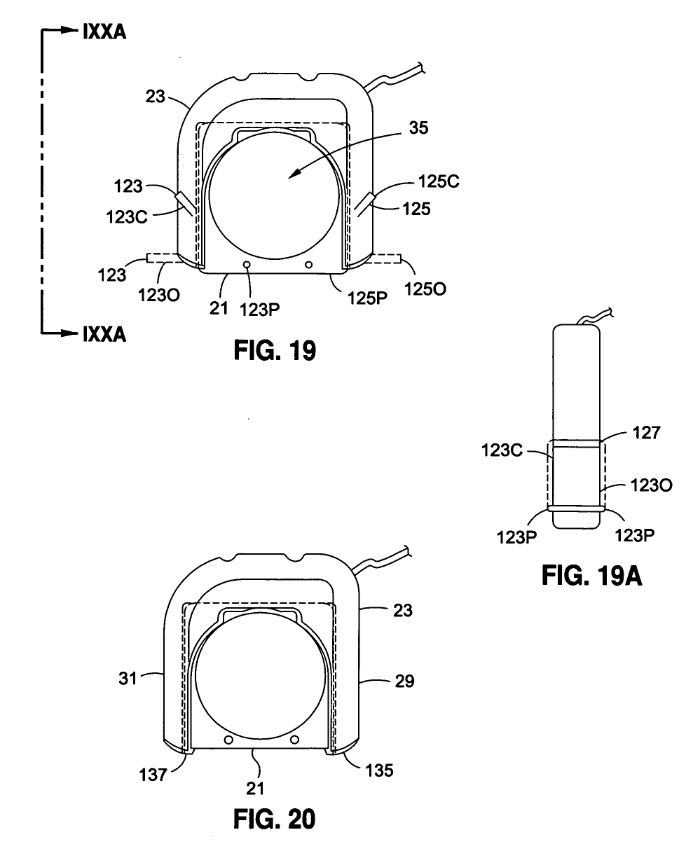

FIG. 19 is a face view of an insert 21 and probe body 23 with another way to secure insert 21 in probe body 23 in a detachable but secure fashion. Clip 123 pivots at point 123P between a closed position 123C where it is secured in notch 127 to an open position 123O. Likewise clip 125 pivots at point 125P between a closed position 125C where it is secured in notch 129 to an open position 125O. FIG. 19A is a side view of probe body 23 of FIG. 19 from position IXX-IXX. Clip 123 is in the open position 123O and loops over the outside of probe body 23 between pivot points 123P on either side of probe body 23. As can be seen, in the open position 123O insert 21 can be removed from probe body 23. However, once clip 123 is snapped into notch 127 in the closed position 123C it securely but detachably holds insert 21 in probe body 23. Clips 123 and 125 can be made of surgical stainless steel, epoxy or any other type of rigid biocompatible rigid material.

FIG. 20 provides another way of securely but detachably securing insert 21 in probe body 23 with the addition of lip or flange 135 at the base of leg 29 which hooks in and lip or flange 137 at the base of leg 31 which also hooks in. Insert 21 when placed in probe body would slip over lips 135 and 137 because of its flexible make up and be securely but detachably held by probe body 23.

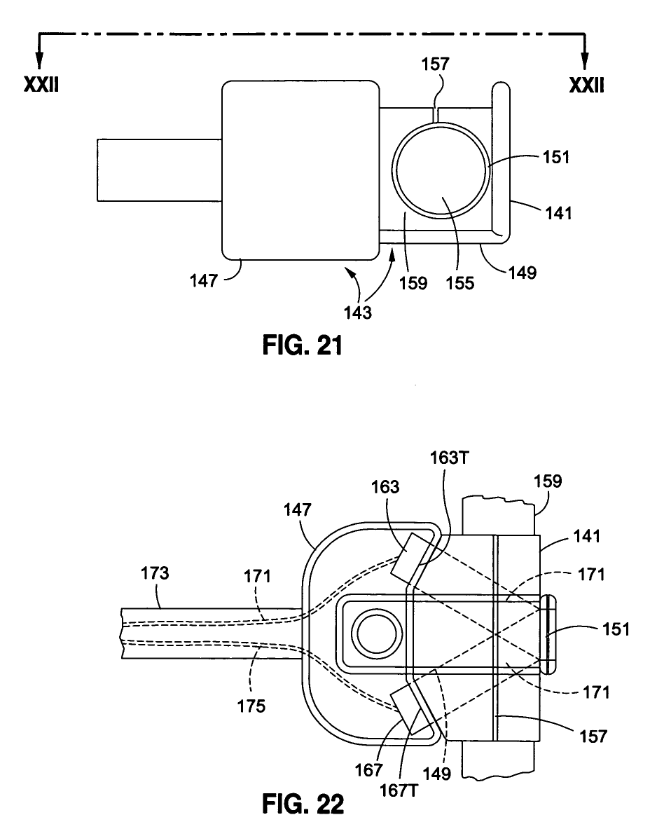

FIG. 21 is a side view of another version of the probe insert with a two transducer set up, with both transducers set up on one side of the vessel and a reflector on the opposite. In FIG. 21 insert 141 is secured in probe 143. Probe 143 consists of a probe body 147 with support arm 149 terminating in reflector arm 151 which is perpendicular to support arm 149 to thereby hold insert 141 between it and probe body 147 and reflecting arm 151. Aperture 155 runs through insert parallel to reflecting surface 151R. Split 157 that runs the length of insert 141 parallel to Aperture 155 allows insert to be secured around conduit or vessel 159 in the same fashion as discussed above. FIG. 22 is a top view of the probe body and insert of FIG. 21 from view XXII-XXII. Arm 149 which is on the opposite side is in outline form. Additionally a first transducer 163 and a second transducer 167 can also be seen in outline form, they actually are embedded in probe body 147. Transmissions between transducer 163 and 167 would pass along path ultrasound path 171, the transmission coming off of and being received by transmission surfaces 163T and 167T with it reflecting off of acoustic reflecting surface 151R. Transducer 163 connects via line 173 through probe stem 173 to a CPU or flowmeter, not shown. Likewise transducer 167 connects by line 175 through probe stem 173 to the CPU or flow meter.

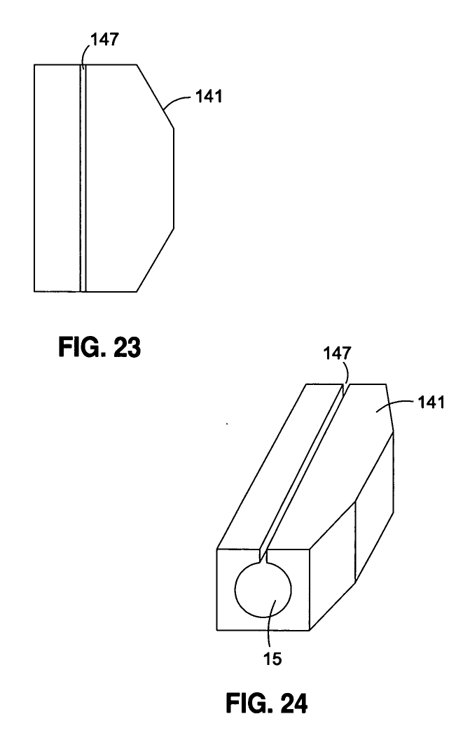

FIG. 23 is a top view of insert 141 and FIG. 24 is a perspective view of the insert 141. The material of both probe body 147 and insert 141 would be made of the same materials and in the same fashion as discussed above.

While the invention has been particularly shown and described with reference to a preferred embodiment thereof, it will be understood by those skilled in the art that various changes in form and detail may be made to it without departing from the spirit and scope of the invention.

We claim:

1. An insert for a perivascular probe comprising:
a) a probe insert with a body made of a pliable flexible material having a lumen surface formed on an interior portion of said insert, said lumen surface ending at two opposing openings and thereby defining an aperture through said insert, which aperture is sized such that said lumen surface can be securely, snugly and detachably fitted to a portion of an exterior surface of a fluid conduit with a specific exterior dimension, said insert also including a split region to facilitate fitting of the insert to the fluid conduit;
b) said probe insert having an exterior surface configured to securely but detachably fit within an interior space of a probe body, the probe body having appropriately placed within it at least two ultrasonic transducers configured to exchange transmissions there between, which transmissions provide full flow illumination of the interior of a conduit positioned against said lumen surface of said insert, when said insert is positioned within the probe; and
c) wherein said pliable flexible material of said insert is ultrasonically matched to material making up a conduit held by said insert and fluid flowing in the conduit to thereby eliminate distortion of ultrasonic transmissions passing through the conduit.

2. The insert of claim 1 further comprising a set of inserts each sized to fit in the same probe body but with a different sized aperture formed by said lumen surface to thereby provide a set of inserts that can be detachably but securely fitted to the exterior surface of fluid conduits of different specific exterior sizes to thereby allow the probe body to be acoustically coupled with fluid conduits of different specific sizes that correspond to said apertures of said set of inserts.

3. The insert of claim 1 wherein said insert has a flange attached to and extending from a position adjacent to said lumen surface at each opening to thereby form an extension of the lumen surface.

4. The insert of claim 1 wherein the insert is detachably secured to the inside of the probe body by slightly over sizing said insert to thereby create a secure but detachable friction fit.

5. The insert of claim 1 wherein said insert is detachably secured to the inside of the probe body by one of the following: a) a detachable clip, b) a stitch, and c) by glue.

6. The insert of claim 1 wherein the material from which the insert is made is selected from one of the following: Pebbax 3533 and Tecoflex®.

7. The insert of claim 1 where in the fluid conduit can be a blood vessel of an individual such as an artery or vein.

8. The insert of claim 1 wherein when said insert is secured around a conduit and securely but detachably positioned within said probe body, the insert positions the conduit such that a direction of flow in the fluid conduit is perpendicular to the probe axis of the probe.

9. The insert of claim 1 wherein said lumen surface forms a complete closed cylindrical section and said split region for facilitating placement is a slit in the insert that runs from the lumen surface to the exterior surface of said insert to facilitate creation of a temporary opening through said lumen surface to thereby position said lumen surface over the conduit.

10. The insert of claim 1 wherein said lumen surface forms a partial cylindrical section that is greater than 180° in arc range to thereby allow said insert to be positioned over a conduit.

11. A modular perivascular probe system comprising:
a) a probe body forming an interior pocket to hold an insert in a secure but detachable and snug airtight fit;
b) said probe body having at least two transducers positioned within itself to exchange ultrasonic transmissions there between;
c) an insert made of a pliable and flexible material having an exterior surface configured to fit in a snug airtight fashion within said pocket formed by said probe body;
d) said insert having an aperture there through formed by a lumen surface in an interior of said insert, said lumen surface ending at two opposing openings; such lumen surface is sized such that said lumen surface can be securely, snugly and detachably fitted around a portion of an exterior surface of a fluid conduit of a specific size, in an interior of said insert to thereby create an aperture there through;
e) said lumen surface being configured to hold a vessel in a position that ultra sonic transmissions between the two transducers fully illuminate flow of liquid in the conduit;
f) wherein said pliable flexible material of said insert is ultrasonically matched to material making up the conduit held by said insert and fluid flowing in the conduit to thereby eliminate distortion of ultrasonic transmissions passing through the conduit; and
g) wherein said at least two transducers are connected by a communication link to a cpu, which cpu is programmed to control the operation of said at least two transducers and obtain signal information from signals transmitted between said at least two transducers to thereby obtain information regarding fluid flowing in the fluid conduit.

12. A method for providing an insert for a perivascular probe, the method comprising:
a) providing a probe insert with a body made of a pliable flexible material having a lumen surface formed on an interior portion of said insert, the lumen surface ending at two opposing openings and thereby defining an aperture through the insert, which aperture is sized such that the lumen surface can be securely, snugly and detachably fitted to a portion of an exterior surface of a fluid conduit with a specific exterior dimension, including in the insert a split region to facilitate fitting of the insert to the fluid conduit;
b) configuring an exterior surface of the insert to securely but detachably allow the insert to fit within an interior space of a probe body, the probe body having appropriately placed within it at least two ultrasonic transducers configured to exchange transmissions there between, which transmissions provide full flow illumination of the interior of a conduit positioned against the lumen surface of the insert, when the insert is positioned within the probe; and
c) ultrasonically matching the material making up the insert to material making up a conduit held by the insert and fluid flowing in the conduit to thereby eliminate distortion of ultrasonic transmissions passing through the conduit.
